(19) United States
(12) Patent Application Publication
(10) Pub. No.: US 2014/0231050 A1
(43) Pub. Date: Aug. 21, 2014

(54) Methods and Apparatus for Heating Breast Milk

(71) Applicant: Nutto LLC, Chicago, IL (US)

(72) Inventors: Ami Striker, Chicago, IL (US); Edward Hicks, Sleepy Hollow, IL (US)

(73) Assignee: Nutto LLC, Chicago, IL (US)

(21) Appl. No.: 14/182,746

(22) Filed: Feb. 18, 2014

Related U.S. Application Data
(60) Provisional application No. 61/767,224, filed on Feb. 20, 2013.

(51) Int. Cl. A47J 36/24

(52) U.S. Cl. CPC A47J 36/2411
USPC 165/80.5

(57) ABSTRACT

In exemplary implementations of this invention, a warmer is configured to hold warm water and a container of chilled or frozen breast milk, and to heat the breast milk by heat transfer from the water to the breast milk. The warmer may comprise a vessel (for holding the warm water), flexible bristles and a lid/dome. The vessel is insulated by a vacuum layer. The water can be poured into a cavity in the vessel. The vessel is penetrated by a hole that opens into the cavity. In exemplary implementations, the flexible bristles protrude into the hole, and are configured (i) to be elastically deformed when a human user inserts or removes a breast milk container through the hole, and (ii) to inhibit bobbing of the container, due to buoyancy.

### RELATED APPLICATIONS

This application is a non-provisional of, and claims the benefit of the filing date of, U.S. Provisional Application No. 61767224, filed Feb. 20, 2013, the entire disclosure of which is herein incorporated by reference.

### FIELD OF THE TECHNOLOGY

The present invention relates generally to warming refrigerated or frozen breast milk, by heat transfer from warm water.

### BACKGROUND OF THE INVENTION

It is preferable to warm frozen or chilled breast milk to body temperature, before feeding it to a baby. Heating the breast milk in a microwave or directly on a stove is not recommended, because the breast milk may overheat. There are at least two problems with overheating: First, and most importantly, excessive heat may destroy nutritional properties of the breast milk. Second, overheating may result in the baby's mouth being burned, or a bottle melted.

Accordingly, it is preferable to use warm water (e.g., warm tap water) to heat the chilled or frozen breast milk. This prevents the breast milk from overheating.

### SUMMARY

In exemplary implementations of this invention, a warmer is configured to hold warm water and a container of chilled or frozen breast milk, and to heat the breast milk by heat transfer from the warm water to the breast milk. For example, the warm water may be hot tap water.

The warmer may comprise a vessel (for holding the warm water), flexible bristles and a lid/dome. The vessel has an inner wall and an outer wall, both comprised of stainless steel. A vacuum layer, situated between the inner and outer walls, provides insulation. The water can be poured into a cavity in the vessel. The vessel is penetrated by a hole that opens into the cavity.

In exemplary implementations, the flexible bristles protrude into, and partially obstruct, the hole.

The flexible bristles elastically deform when a human user, by hand, inserts or removes a breast milk container through the hole.

Furthermore, the flexible bristles are advantageous when water has been poured into the warmer's vessel, and the breast milk container is floating upon or immersed in the water. In that context, the flexible bristles restrain bobbing of the breast milk container—they prevent the container from riding too high above the level of the water. Thus, the bristles facilitate rapid heating, because the greater the portion of the breast milk container that is submerged in the warm water, the faster the breast milk heats. Also, the bristles prevent the container from bobbing so high that it flips on its side.

The description of the present invention in the Summary and Abstract sections hereof is just a summary. It is intended only to give a general introduction to some illustrative implementations of this invention. It does not describe all of the details of this invention. This invention may be implemented in many other ways.

### BRIEF DESCRIPTION OF THE DRAWINGS

FIG. 1 shows a side view of a warmer for heating breast milk.

FIG. 2A shows a top view of a set of flexible bristles arranged in a radial pattern.

FIG. 2B shows a cross-section of a flexible bristle.

FIG. 3 shows a cross-section of a warmer for heating breast milk

FIG. 4 shows an exploded view of a warmer for heating breast milk.

FIG. 5 shows another cross-section of a warmer for heating breast milk.

FIG. 6 is a conceptual diagram that shows features that facilitate fast warming rate of breast milk.

FIG. 7 is a conceptual diagram that shows features that facilitate one-handed use by a human female.

FIG. 8 is a conceptual diagram that shows bristle parameters.

The above Figures show some illustrative implementations of this invention, or provide information that relates to those implementations. However, this invention may be implemented in many other ways. The above Figures do not show all of the details of this invention.

### DETAILED DESCRIPTION

In exemplary implementations of this invention, an insulated vessel is configured to hold warm water and a container of chilled or frozen breast milk, and to heat the breast milk by heat transfer from the warm water to the breast milk.

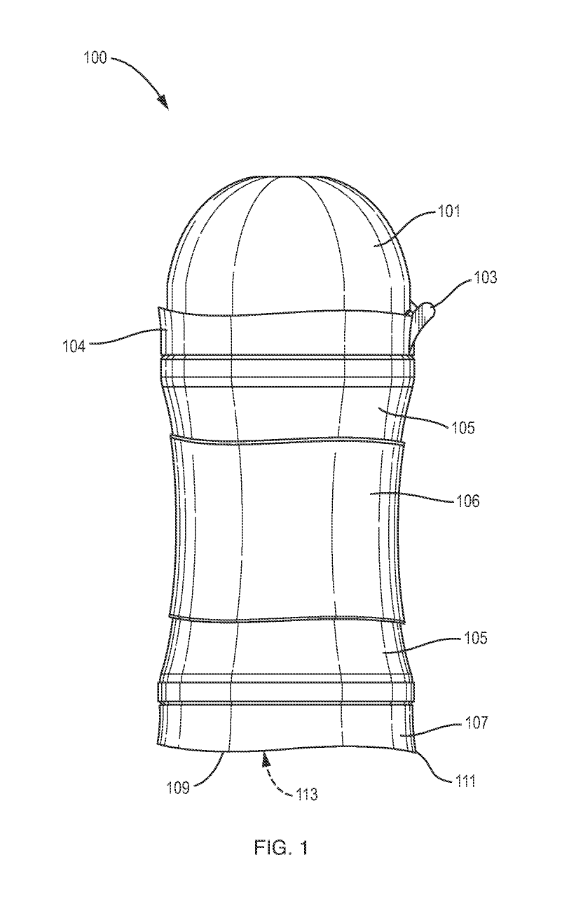

FIG. 1 shows a side view of a warmer 100 for heating breast milk, in an illustrative implementation of this invention. The warmer 100 includes an outer steel wall 105 of a vacuum-insulated vessel, a plastic neck 104, and a lid 101 attached to the neck 104 by a hinged joint 103. The warmer 100 has a waist, with a narrower diameter than surrounding regions of the warmer. The waist is covered by a soft silicon grip 106. The warmer 100 rests on three contact areas 109, 111, 113 of a plastic base 107.

In illustrative implementations of this invention, a cavity within the insulated vessel is connected to the outside environment by a hole. Warm water may be poured through the hole into the cavity, to fill the cavity fully or partially. A neck 104 encircles the hole. Flexible bristles partially obstruct the hole, creating an elastically deformable barrier through which a human can insert or remove a bottle or other container of breast milk. The flexible bristles also inhibit the bottle or other container from bobbing up out of the water, due to buoyancy.

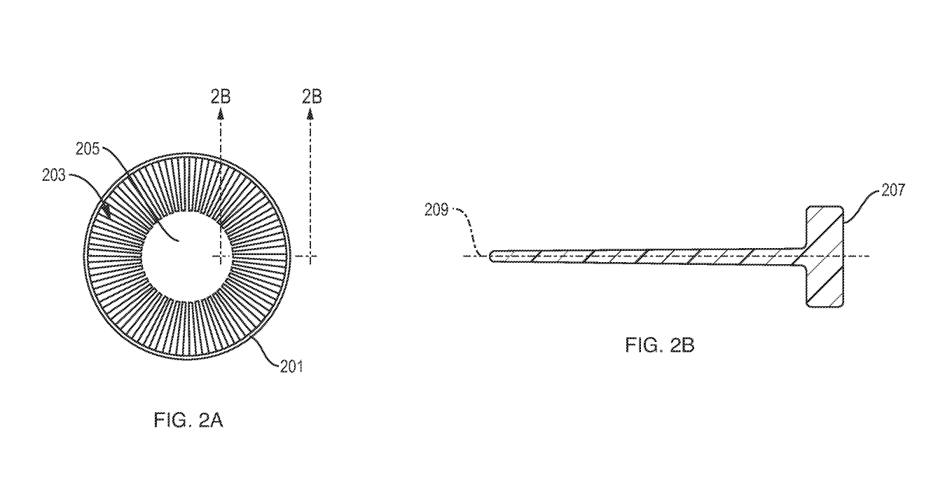

FIG. 2A shows a top view of a set of flexible bristles 203, in an illustrative implementation of this invention. The bristles 203 are arranged in a radial pattern. Each bristle is elongated and oriented lengthwise along a line radiating from a central point. One end of each bristle is affixed to an annular bristle holder 201. The annular bristle holder 201 rests on an inner ledge of the vessel and is positioned adjacent to an inner wall of the neck 104. The bristles 203 do not extend all of the way into the hole, leaving a central opening 205 that is unobstructed by bristles. The bristle holder 201 may be of any shape, and is not limited to being in a circular shape.

FIG. 2B shows a vertical cross-section of a flexible bristle, in an illustrative implementation of this invention. A bristle has an overall elongated shape. The overall elongated shape may, but is not necessarily, the overall shape shown in FIG. 2B: i.e., a main body 207 and a tapered portion that ends at a tip 209. In the example in FIG. 2B, the main body 207 is affixed to a bristle holder (not shown in FIG. 2B).

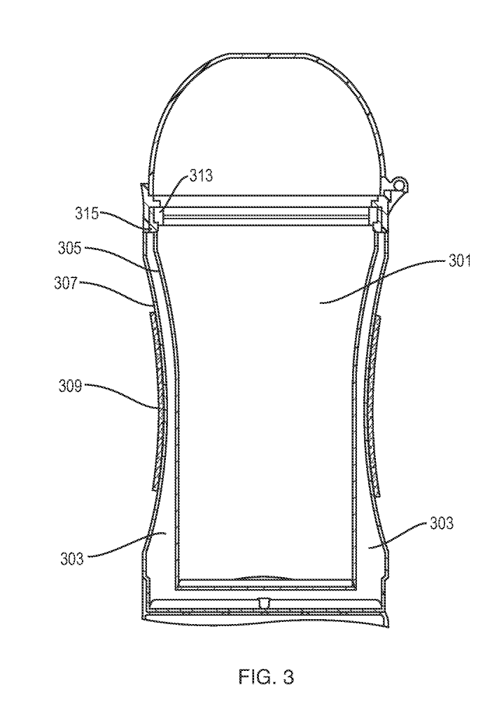

FIG. 3 shows a cross-section of a warmer for heating breast milk, in an illustrative implementation of this invention. A vessel surrounds a cavity 301. The vessel comprises an outer steel wall 307 and an inner steel wall 305. The vessel is insulated by a vacuum 303 between the inner wall 305 and outer wall 307. A silicon grip 309 surrounds a narrow waist region of the vessel. A bristle holder 313 rests on an inner ledge 315 of the vessel. The bristle holder holds bristles that extend into a hole at the top of the vessel.

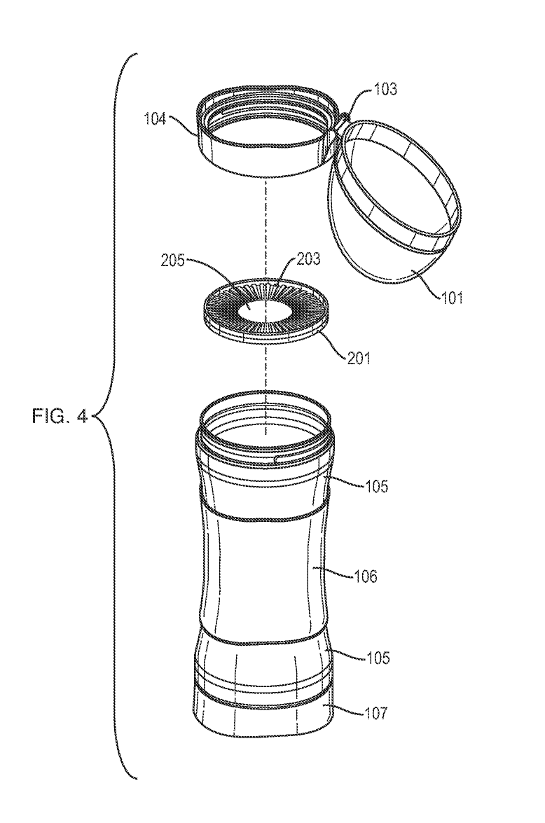

FIG. 4 shows an exploded view of a warmer for heating breast milk, in an illustrative implementation of this invention.

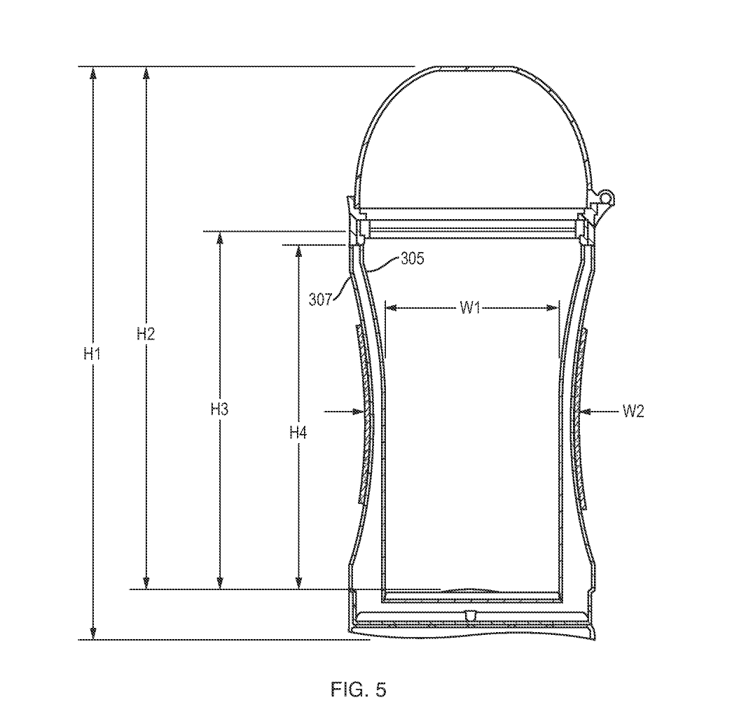

FIG. 5 shows another cross-sectional view of a warmer for heating breast milk, in an illustrative implementation of this invention. For example, the warmer may be implemented with the following dimensions, as shown in FIG. 5: H1 (bottom of base to top of lid) equals 10.20 inches; H2 (bottom of cavity to top of lid) equals 9.28 inches; H3 (bottom of cavity to bristles) equals 6.40 inches, H4 (bottom of cavity to bottom of neck) equals 6.19 inches; W1 (inner waist thickness, from one edge of cavity to other edge of cavity, at waist of the warmer) equals 3.15 inches; and W2 (outer waist thickness, from exterior of outer wall to exterior of other outer wall, at waist of the warmer) equals 3.80 inches. This invention may be implemented with different dimensions, including other values for each of the above dimensions (H1, H2, H3, H4, W1, W2).

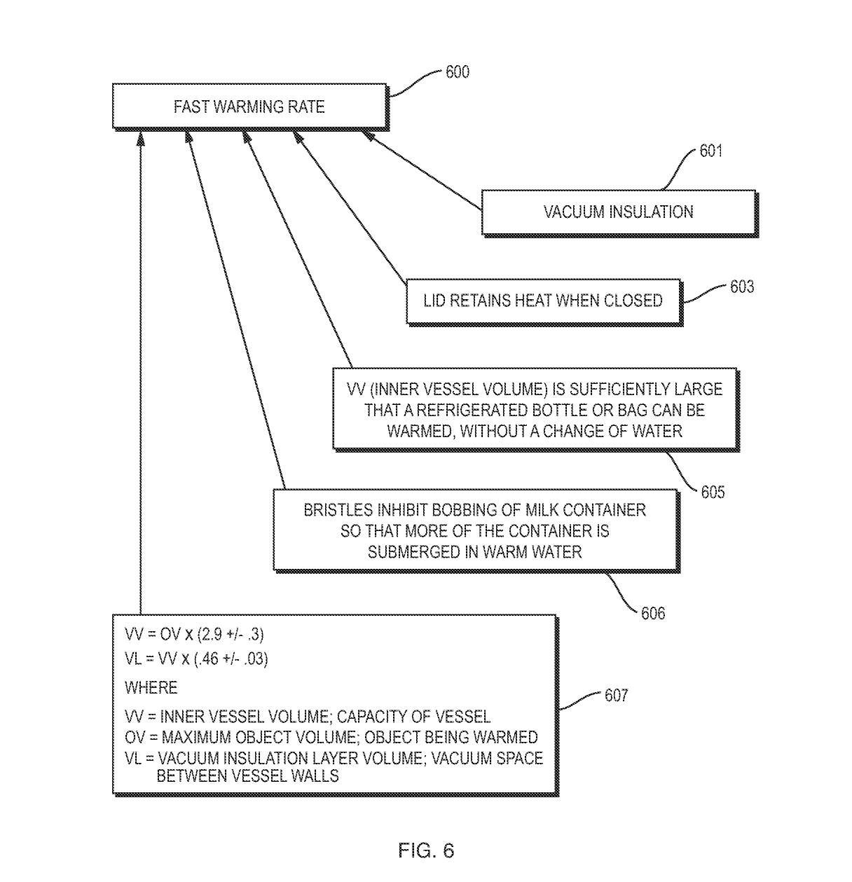

Preferably, the warmer includes features that facilitate rapid heating of breast milk by warm water. FIG. 6 is a conceptual diagram that shows some of these features that result in a fast warming rate 600, in an exemplary embodiment of this invention. First, vacuum insulation is employed 601. Second, a lid retains heat when the lid is closed 603. Third, the volume of the cavity (also called the inner vessel volume or VV) is sufficiently large that a refrigerated bottle, bag or other container of breast milk can be heated, without a change of water 605. Fourth, flexible bristles tend to keep the bottle, bag or other container of breast milk submerged in the warm water 606. Fifth, the following relative proportions may be used 607:

VV=OV×(2.9±0.3) Equation 1

VL=VV×(0.46±0.03) Equation 2

where VV equals the volume of the cavity 301 (also known as the inner vessel volume; OV equals the maximum volume of an object (e.g., bottle) being heated; and VL equals the volume of the vacuum insulation layer 303.

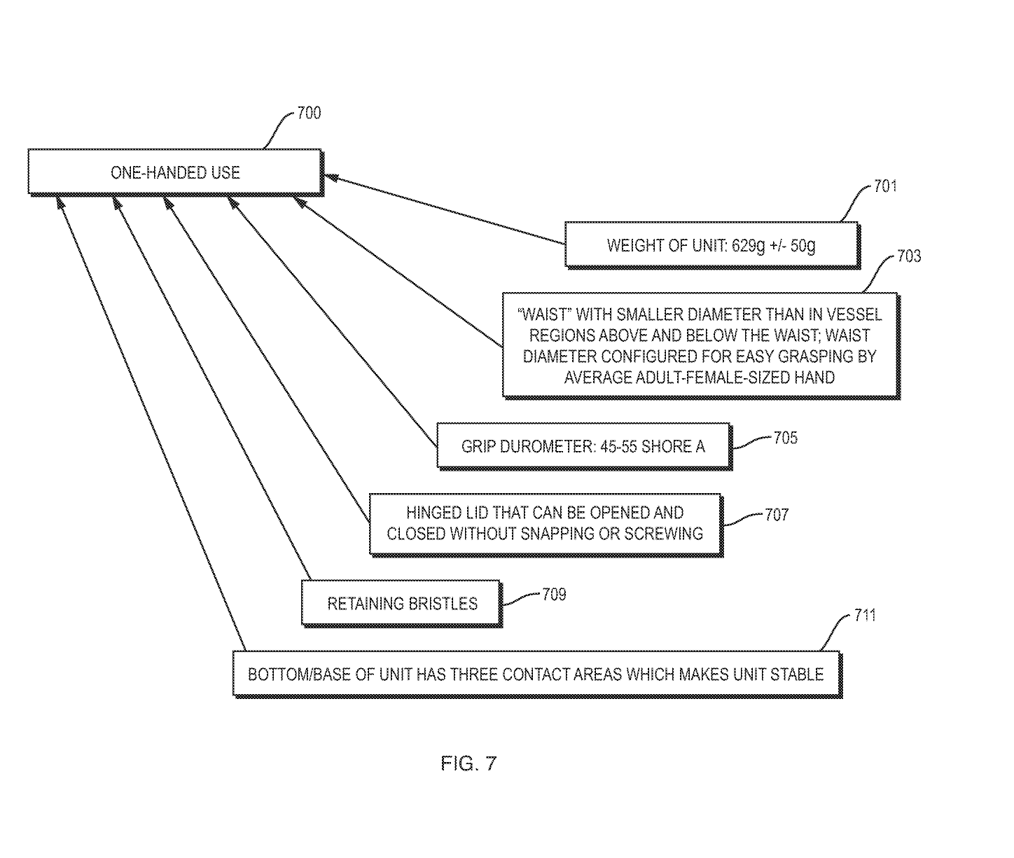

Preferably, the warmer includes features that facilitate one-handed use of the warmer. For example, these features would facilitate one-handed use by a mother holding a baby with one arm/hand and using the other hand to warm breast milk in the warmer. FIG. 7 is a conceptual diagram that shows some of these features that facilitate one-handed use 700 of the warmer, in an exemplary embodiment of this invention. First, the weight of the warmer is 629 g±50 g 701. Second, the vessel has a waist that has a narrower diameter than regions of the vessel above and below the waist. The waist has a diameter that is configured for easy grasping by an average adult female-sized human hand 703. Third, the grip around the waist has a hardness between 45 Shore A durometer and 55 Shore A durometer 705. Fourth, the warmer has hinged lid that can be opened and closed without snapping or screwing 707. Fifth, the warmer has flexible bristles that protrude partway into the hole in the vessel, such that the bristles are configured to restrain a bottle (or other container of breast milk) from bobbing too high out of water in the cavity 709. Sixth, the bottom or base of the warmer has three contact areas which makes the warmer stable (harder to tip over) 711.

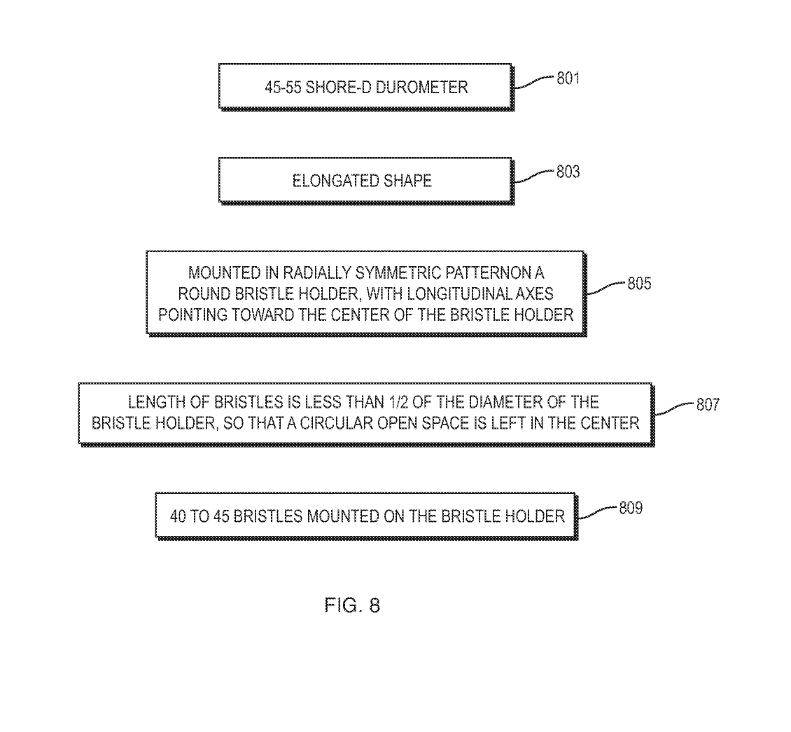

FIG. 8 is a conceptual diagram of some bristle parameters, in an exemplary embodiment of this invention. In this embodiment, the bristles: (a) have a hardness between 45 shore D durometer and 55 shore D durometer 801; (b) have an elongated shape 803; (c) are mounted in a radially symmetric pattern on a bristle holder, with longitudinal axes of the bristles pointing toward the center of the bristle holder 805; and (c) have a length that is less than one half of the diameter of the bristle holder, so that a circular open space is left in the center 807. In this embodiment, there are 40 to 45 bristles mounted on the bristle holder 809.

In a prior art breast milk heating method, the breast milk is placed in a bottle, bag or other storage container in a mug, bowl or other kitchen item that has been filled with warm water. A problem with this prior art method is the buoyancy of the bottle, bag or other container. Specifically, the bottle or bag of milk will bob up and down and usually end up on its side on top of the water, rather than submerged in it.

In exemplary implementations of this invention, this problem is solved by using bristles. The bristles restrain a breast milk container (e.g., bottle, bag or other container that contains breast milk) from rising due to buoyancy, so that the container is submerged in water, where it will warm. Flexible bristles keep the container submerged in the water for heating. For example, when the warmer is filled with water, the flexible bristles come into contact with the neck/shoulders of a bottle to keep it upright and submerged, or come into contact with the top of a storage bag to keep the bag submerged. This causes more efficient and faster heating.

In exemplary implementations of this invention: (a) the bristles comprise a flexible polypropylene (or other polyolefin) for easy insertion and removal of a bottle, bag or other container of milk, while also providing effective restraint of container to solve the aforementioned problem of “bobbing”; and (b) the bristles have a hardness of 45-55 Shore-D durometer. In this range of Shore D durometer, the bristles are sufficiently rigid that they restrain the milk container from bobbing out of the water and are sufficiently soft that a user can easily, by hand, insert or remove a bottle or other container through the bristles.

In exemplary implementations of this invention, a bristle holder (e.g., 201) (to which bristles 203 are attached) rests on an inner ledge of the warmer. See FIGS. 2 and 3). This keeps the bristle holder in place when a bottle or other container (e.g. containing breast milk) is pushed through the bristles into the cavity or pulled out through the bristles from the cavity. The shape of the bristles themselves may be long and slightly triangular, coming to soft point at the end. Together the bristles may form a hollow circle in the center of the round piece. A bottle or other container of breast milk can be pushed through this hollow circle, causing the bristles around the edges to elastically bend.

In an illustrative implementation of this invention, a bristle holder houses vertically symmetrical triangular bristles that are arranged in a radial pattern. Each bristle holder holds approximately 40 to 45 bristles. The bending force and retaining force of the bristles is nearly equal in either direction. This allows the object being heated to be inserted or removed easily while retaining it securely to ensure heating. The bristles can be installed in the warmer in any radial orientation—i.e., the round flat housing of the bristles can be rotated about its center to any angle, and the round piece can be installed with either flat surface facing upward or downward. This is advantageous from both a user and a manufacturing standpoint.

Prior art breast milk warmers often suffer from another problem: difficulty of use. The difficulty may arise, for example, from: (1) complicated assembly requirements; (2) complicated and difficult measuring processes (e.g. precise measurement of water requirements); or (3) difficulty in using with just one hand.

In an illustrative implementation of this invention, a breast milk warmer is configured to be used as follows: A human user places the pre-assembled warmer in the sink (or on countertop/chosen surface area) and opens the dome/lid. The dome/lid rests on a hinge so the entire unit stays intact. The user places the bottle, bag or other container of refrigerated or frozen breast milk in the warmer by pushing it past the flexible bristles (i.e., by elastically bending the bristles). The top of taller bottles, bags or other containers (which contain breast milk) will be just above the bristles (e.g. the bristles will be positioned at the bottle neck or shoulders with the bottle nipple above the bristles). Shorter bottles can also be placed inside the warmer completely. However, when the warmer is filled with water, buoyancy will elevate even a shorter bottle so that the neck and nipple of the shorter bottle are above the bristles. The user can fill the warmer with warm water until the user sees the water coming through the holding bristles. The user can then close the lid/dome.

When a user feels sufficient time has passed, the user can remove the bottle, bag or other container of milk from the warmer, swirl the milk and test the temperature on his or her wrist to ensure optimal feeding temperature. The amount of time required to warm the milk to desired temperature varies depending on inputs such as temperature of water, temperature of milk in container, quantity of milk in container, etc.

In exemplary implementations of this invention, there is no need for the user to assemble any part of the warmer in preparation for or during ordinary use. None of its components need to be removed, unassembled or reassembled for ordinary use. However, the neck, dome/lid and bristles can be unassembled and re-assembled for periodic cleaning of the unit. For this unassembly and reassembly, the neck is twisted/screwed off and back on.

In exemplary implementations, no complicated water measurement is required for use. The human user simply fills the vessel/warmer until the water is visible through the bristles (this ensures a sufficient amount of water, but if the water overflows, it doesn't affect heating).

In exemplary implementations, this invention is configured to be used single-handedly—e.g., in the event that a baby is being held in the other hand or the user is multi-tasking as often is the case when caring for a baby. See FIG. 5. In exemplary embodiments, the following features facilitate one-handed use of the warmer:

(a) The warmer is light weight (629 g+/−50 g), so that it can be easily picked up with one hand.

(b) The warmer has a reduced central “waist” with a diameter configured for an average adult female-sized hand to pick up and hold onto.

(c) A grip (or wrap) around the waist helps prevent slippage in the hand. The grip may comprise silicone, with a hardness of 45-55 Shore A, for a soft feel and effective grip.

(d) The warmer has a neck and dome-shaped lid for easy access into the warmer, lid closure and easy access out of the warmer. The neck may be implemented as a top ring. The lid is attached to a hinge joint, and can be easily flipped open and closed with one hand with no snapping or screwing of the lid required. The lid may comprise polyethylene, have a hardness of 75 Shore-D durometer, and be smooth and easy to clean. The lid may have a raised surface feature for ease of gripping.

(e) The warmer has a stable base so it can be placed on and stand upright on most surfaces. The bottom or base of the warmer may have three contact areas which makes the warmer stable and “non-rocking”.

(f) Flexible bristles are configured to permit easy insertion and removal of bottle, bag or other container of milk (while also restraining the container from “bobbing”).

In exemplary implementations, the warmer is easy to maintain: Stainless steel and plastic materials (e.g. polyethylene) allow the warmer to be placed and left inside a sink, thereby avoiding water spillage on countertops, etc. The warmer is easy to clean (soap and warm/warm water) and easy to unassemble for cleaning and re-assemble after cleaning Moreover, the entire warmer can be stored in a fully assembled state, so that when the warmer is not in use, all components remain attached, intact and in one place. This helps prevent loose parts from being misplaced or lost.

One problem with heating refrigerated and/or frozen pumped breast milk with warm water is the long time it can take to get the milk heated to optimal feeding temperature (typically, body temperature as the baby would experience if coming directly from the mother's breast).

In exemplary embodiments of this invention, the warmer heats the breast milk rapidly, by heat transfer from warm or warm water.

According to principles of this invention, Equations 1 and 2 above describe a configuration for heating milk rapidly. Equations 1 and 2 were determined from empirical analysis, testing and verification.

In illustrative implementations, this invention is configured to satisfy Equations 1 and 2. For example, the following configuration for a warmer would satisfy Equations 1 and 2: inner vessel volume is 29 fluid oz.; vacuum insulation layer volume is 13.4 fluid oz.; and the maximum size of the bottle to be heated is 10 fluid oz.

Furthermore, in exemplary implementations, inside and outside stainless steel walls are thermally separated with a layer of vacuum. Vacuum is an excellent thermal insulator (as opposed to less efficient thermal insulators such as Styrofoam or air alone).

In an illustrative embodiment of this invention, inner and outer walls of a vessel comprise 1018 Food Grade Stainless Steel. The stainless steel vessel is welded together and polished, to form a food-grade polished weldment.

In illustrative embodiments, the size of the warmer is sufficiently large that it can hold enough warm water so that a refrigerated bottle or bag can be heated without a change of water. In contrast, when a mug or bowl is used to hold warm tap water for heating breast milk (in a prior art method), at least one change of water may be needed and most often more than one change is needed. For example, a conventional mug may have a capacity of 8.0-16.0 ounces of water. In contrast, in some implementations of this invention, the warmer houses approximately 29 ounces.

### Definitions and Clarifications:

Here are a few definitions and clarifications. As used herein:

The terms “a” and “an”, when modifying a noun, do not imply that only one of the noun exists.

The term “bristle” shall be construed broadly. For example: (a) a “bristle” may comprise a bristle or a finger, (b) a “bristle” may be flexible; and (c) a “bristle” may comprise a retaining or holding bristle. For purposes of the preceding sentence, the term “finger” does not include a part of a human or other organism.

The term “comprise” (and grammatical variations thereof) shall be construed broadly, as if followed by “without limitation”. If A comprises B, then A includes B and may include other things.

The term “container” shall be construed broadly. For example, the term “container” includes a bottle, bag or other container.

The term “e.g.” means for example.

The fact that an “example” or multiple examples of something are given does not imply that they are the only instances of that thing. An example (or a group of examples) is merely a non-exhaustive and non-limiting illustration.

Unless the context clearly indicates otherwise: (1) a phrase that includes “a first” thing and “a second” thing does not imply an order of the two things (or that there are only two of the things); and (2) such a phrase is simply a way of identifying the two things, respectively, so that they each can be referred to later with specificity (e.g., by referring to “the first” thing and “the second” thing later). For example, unless the context clearly indicates otherwise, if an equation has a first term and a second term, then the equation may (or may not) have more than two terms, and the first term may occur before or after the second term in the equation. A phrase that includes “a third” thing, a “fourth” thing and so on shall be construed in like manner.

The term “hole” shall be construed broadly, and includes an opening.

The terms “horizontal” and “vertical” shall be construed broadly. For example, “horizontal” and “vertical” may refer to two arbitrarily chosen coordinate axes in a Euclidian two dimensional space.

The term “include” (and grammatical variations thereof) shall be construed broadly, as if followed by “without limitation”.

The term “or” is inclusive, not exclusive. For example “A or B” is true if A is true, or B is true, or both A or B are true. Also, for example, a calculation of “A or B” means a calculation of A, or a calculation of B, or a calculation of A and B.

A parenthesis is simply to make text easier to read, by indicating a grouping of words. A parenthesis does not mean that the parenthetical material is optional or can be ignored.

The term “warm” means warm or hot. For example, 110 degrees Fahrenheit is warm.

### Variations:

This invention may be implemented in many different ways, in addition to those described above. Here are some non-limiting examples:

The overall size and shape of the warmer is flexible. Colors can be changed, and the warmer can be customized (e.g., for particular retailers, target audience, bottle/bag/container sizes, etc.)

The vessel size can be reduced or increased.

Different insulation materials can be used, other than vacuum. A material other than stainless steel (e.g., copper or another metal) may be used for the vessel's inner and outer walls. Other materials (e.g., styrene, polyethylene, or acrylonitrile butadiene styrene) may be used for the ring-shared part, the dome/lid, or base.

This invention is not limited to using only 40-45 bristles. A different number of bristles may be used. The bristles may be housed in more than one ring. In an illustrative embodiment of this invention, the bristles may be housed in a non-circular shape—for example, a shape customized to restrain a particular, non-circular container of breast milk. A material, other than polyethylene, may be used for the bristles. For example, bristles may comprise TPU (thermoplastic polyurethane), polyethylene, silicon, nylon, polycarbonate, or other materials.

Different durometers may be used for the bristles. For example, the bristles may have a hardness from 25 Shore-D up to 85 Shore-D. Which durometer is preferable for the bristles depends on the particular implementation, including the number of bristles in a particular implementation.

This invention may be implemented as an article of manufacture that comprises, in combination: (a) a vessel; and (b) bristles; wherein: (i) the vessel is configured to contain water within a cavity in the vessel; (ii) the vessel is penetrated by a hole that opens into the cavity, (iii) the bristles protrude into the hole, and (iv) the bristles are configured (A) to be elastically deformed when a human user, by hand, inserts or removes a container through the hole, and (B) to inhibit bobbing of the container, which bobbing is due to buoyancy of the container when in the water. Furthermore: (1) the vessel may be vacuum-insulated; (2) the vessel may be configured to warm breast milk in the container, due to heat transfer from the water; (3) the bristles may each, respectively, have a hardness between 45 shore D durometer and 55 shore D durometer; (4) the hole may be circular and have a center, and the bristles may be elongated and oriented in a radial pattern, such that each respective bristle is oriented lengthwise along a line radiating from the center; (5) the bristles may be positioned so that the bristles do not extend into a central region of the hole; (6) the bristles may comprise polypropylene; (7) the vessel may be insulated by a vacuum between walls of the vessel, the vacuum may have a first volume, and the cavity may have a second volume, and the first volume may be equal to the product of the second volume and a number, which number is between 0.43 and 0.49; (8) the vessel may have a waist region which is located between two other regions of the vessel, and the waist region may be narrower than the two other regions; (9) the article of manufacture may further comprise a lid, the lid may be attached to a hinged joint, and the lid may be configured to move about the joint, relative to the vessel, to cover or uncover the hole, without snapping or screwing; (10) the vessel may be configured to rest on three contact areas; and (11) the vessel may include a first wall and a second wall, with vacuum insulation between the first and second wall; and the first and second walls may comprise metal.

This invention may be implemented as an article of manufacture that comprises, in combination: (a) a vacuum-insulated vessel; and (b) bristles; wherein (i) the vessel is penetrated by a hole that connects to a cavity inside the vessel, (ii) the bristles each, respectively, protrude into the hole, (iii) the hole and bristles together comprise an elastically deformable orifice through which a human user can, by hand, insert a container into water in the cavity, which container contains breast milk, and (iv) the hole and bristles together comprise means for inhibiting bobbing of the container when the container floats in the water. Furthermore, the hole may be circular and have a center; and the bristles may be elongated and oriented in a radial pattern, such that each respective bristle is oriented lengthwise along a line radiating from the center.

This invention may be implemented as an article of manufacture that comprises, in combination: (a) a vacuum-insulated vessel; and (b) bristles; wherein (i) the vessel surrounds a cavity, (ii) the vessel is penetrated by a hole, which hole connects the cavity and a volume exterior to the vessel, (iii) each respective bristle, out of the bristles (A) is situated such that the respective bristle extends into the hole, and (B) has a hardness between 45 shore D durometer and 55 shore D durometer, (iv) the vessel has a first diameter at a first region, a second diameter at a second region, and a third diameter at a third region, (v) the second region is situated between the first and third regions, and (vi) the second diameter is less than the first diameter and less than the third diameter. Furthermore: (1) the bristles may comprise means for inhibiting bobbing of a container floating in water in the vessel; (2) the cavity may have a first volume and the container may have a maximum volume, and the first volume may be equal to the product of the maximum volume and a number, which number is between 2.6 and 3.2; (3) the article of manufacture may further comprise a grip, and the grip may surround the second region; (4) the grip may comprise silicon and have a hardness between 45 shore A durometer and 55 shore A durometer; and (5) the vessel may be insulated by a vacuum, the cavity may have a first volume and the vacuum may have a third volume, and the third volume may be equal to the product of the first volume and a number, which number is between 0.43 and 0.49.

### Conclusion:

While exemplary implementations are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention. Numerous modifications may be made by one of ordinary skill in the art without departing from the scope of the invention.

What is claimed is:

1. An article of manufacture that comprises, in combination:
(a) a vessel; and
(b) bristles;
wherein:
(i) the vessel is configured to contain water within a cavity in the vessel;
(ii) the vessel is penetrated by a hole that opens into the cavity,
(iii) the bristles protrude into the hole, and
(iv) the bristles are configured
(A) to be elastically deformed when a human user, by hand, inserts or removes a container through the hole, and
(B) to inhibit bobbing of the container, which bobbing is due to buoyancy of the container when in the water.

2. The article of manufacture of claim 1, wherein the vessel is vacuum-insulated.

3. The article of manufacture of claim 1, wherein the vessel is configured to warm breast milk in the container, due to heat transfer from the water.

4. The article of manufacture of claim 1, wherein the bristles each, respectively, have a hardness between 45 shore D durometer and 55 shore D durometer.

5. The article of manufacture of claim 1, wherein:
(a) the hole is circular and has a center; and
(b) the bristles are elongated and oriented in a radial pattern, such that each respective bristle is oriented lengthwise along a line radiating from the center.

6. The article of manufacture of claim 5, wherein the bristles do not extend into a central region of the hole.

7. The article of manufacture of claim 1, wherein the bristles comprise polypropylene.

8. The article of manufacture of claim 1, wherein:
(a) the vessel is insulated by a vacuum between walls of the vessel;
(b) the vacuum has a first volume, and the cavity has a second volume; and
(c) the first volume is equal to the product of the second volume and a number, which number is between 0.43 and 0.49.

9. The article of manufacture of claim 1, wherein:
(a) the vessel has a waist region which is located between two other regions of the vessel; and
(b) the waist region is narrower than the two other regions.

10. The article of manufacture of claim 9, wherein:
(a) the article of manufacture further comprises a lid;
(b) the lid is attached to a hinged joint; and
(c) the lid is configured to move about the joint, relative to the vessel, to cover or uncover the hole, without snapping or screwing.

11. The article of manufacture of claim 1, wherein the vessel is configured to rest on three contact areas.

12. The article of manufacture of claim 1, wherein:
(a) the vessel includes a first wall and a second wall, with vacuum insulation between the first and second walls; and
(b) the first and second walls comprise metal.

13. An article of manufacture that comprises, in combination:
(a) a vacuum-insulated vessel; and
(b) bristles;
wherein
(i) the vessel is penetrated by a hole that connects to a cavity inside the vessel,
(ii) the bristles each, respectively, protrude into the hole,
(iii) the hole and bristles together comprise an elastically deformable orifice through which a human user can, by hand, insert a container into water in the cavity, which container contains breast milk, and
(iv) the hole and bristles together comprise means for inhibiting bobbing of the container when the container floats in the water.

14. The article of manufacture of claim 13, wherein:
(a) the hole is circular and has a center; and
(b) the bristles are elongated and oriented in a radial pattern, such that each respective bristle is oriented lengthwise along a line radiating from the center.

15. An article of manufacture that comprises, in combination:
(a) a vacuum-insulated vessel;
(b) bristles;
wherein
(i) the vessel surrounds a cavity,
(ii) the vessel is penetrated by a hole, which hole connects the cavity and a volume exterior to the vessel,
(iii) each respective bristle, out of the bristles
(A) is situated such that the respective bristle extends into the hole, and
(B) has a hardness between 45 shore D durometer and 55 shore D durometer,
(iv) the vessel has a first diameter at a first region, a second diameter at a second region, and a third diameter at a third region,
(v) the second region is situated between the first and third regions, and
(vi) the second diameter is less than the first diameter and less than the third diameter.

16. The article of manufacture of claim 15, wherein the bristles comprise means for inhibiting bobbing of a container floating in water in the vessel.

17. The article of manufacture of claim 16, wherein:
(a) the cavity has a first volume and the container has a maximum volume;
(b) the first volume is equal to the product of the maximum volume and a number, which number is between 2.6 and 3.2.

18. The article of manufacture of claim 15, wherein:
(a) the article of manufacture further comprises a grip;
(b) the grip surrounds the second region.

19. The article of manufacture of claim 18, wherein the grip comprises silicon and has a hardness between 45 shore A durometer and 55 shore A durometer.

20. The article of manufacture of claim 15, wherein:
(a) the vessel is insulated by a vacuum;
(b) the cavity has a first volume and the vacuum has a third volume; and
(c) the third volume is equal to the product of the first volume and a number, which number is between 0.43 and 0.49.
